(19) United States
(12) Patent Application Publication
(10) Pub. No.: US 2002/0134544 A1
(43) Pub. Date: Sep. 26, 2002

(54) Passive cooling system and method

(75) Inventors: Roger S. DeVilbiss, Dallas, TX (US); Kathryn Ostrom, Dallas, TX (US); Overton L. Parish IV, Lubbock, TX (US); Tony Quisenberry, Highland Village, TX (US)

Correspondence Address: JENKENS & GILCHRIST, 3200 Fountain Place, 1445 Ross Avenue, Dallas, TX, 75202-2799, US

(73) Assignee: Thermotek, Inc.

(21) Appl. No.: 09/947,827

(22) Filed: Sep. 6, 2001

Related U.S. Application Data
(60) Provisional application No. 60/230,727, filed on Sep. 7, 2000.

(51) Int. Cl. G05D 23/00; F24F 11/04; F24F 11/06; F24H 3/02

(52) U.S. Cl. 165/287; 165/244; 165/54; 165/291

(57) ABSTRACT

An air conditioning apparatus and method for cooling enclosures containing electronic equipment. More particularly, one aspect of the present invention comprises a low cost passive heat removal system that utilizes a plurality of flat tubing or low profile extrusions. The flat tubing or low profile extrusions are arranged in parallel to create an air-to-air passive heat exchanger which may be incorporated into an air conditioning apparatus constructed in accordance with the present invention. The flat tubes or low profile extrusions offer a greater surface area and more efficient cooling than conventional folded fin designs having the same overall dimensions or volume. Moreover, the flat tubes or low profile extrusions may be manufactured with dimples, fins, or other surface enhancements with little additional labor or manufacturing steps. The air-to-air passive heat exchanger may be arranged in various configurations including cross flow, counterflow or concurrent flow.

### BACKGROUND OF THE INVENTION

1. Field of the Invention

The present invention relates to air conditioning systems, and more particularly, but not by way of limitation, to a passive heat removal system for conditioning the air in an enclosure which shelters heat producing equipment such as a microwave repeater station or other electronic equipment housed in a remote location.

2. History of the Prior Art

It is well known that heat producing equipment such as that found in remote microwave repeater stations or remote cell sites for cellular phone systems, are frequently subjected to very high enclosure temperatures which may have an adverse affect on the equipment. For this very reason, several systems are available for the cooling or conditioning of the air in the electronic enclosures. The technology used for cooling relate to and include passive cooling systems, compressor-based cooling systems, thermoelectric cooling systems and combinations thereof.

Currently, in the electronic enclosures cooling market, there are generally two types of passive heat exchangers in use. The first type is a folded fin heat exchanger that takes thin sheets of aluminum and folds these sheets into a heat exchanger core with manifolds or seals at the ends to isolate one air path from another. However, this type of heat exchanger core has watt density limitations which drive up the costs of such a design. This type of heat exchanger core is discussed further in commonly assigned U.S. Pat. No. 6,058,712 for use in the passive portion of a hybrid (active/passive) cooling system. The second type of heat exchanger is a heat pipe core as set forth and described in commonly assigned U.S. Pat. No. 5,890,371 for use as the passive heat exchanger in a hybrid system. This particular type of heat exchanger can support higher watt densities, but it usually cannot be configured to a low depth design due to the need for gravity to assist in the phase change process.

In both types of passive cooling systems, the air to be cooled is circulated over an air-to-air heat exchanger, which includes folded fin heat exchangers, heat pipes, etc. The heat is then exchanged with the outside ambient air. As the amount of heat to be removed from the enclosure increases, the size of the air-to-air heat exchanger must also be increased in size. In cases where watt densities are particularly high, the amount of surface area required for passive heat removal makes prior art systems rather difficult to implement. This is because it is typically very difficult to create a passive heat exchanger unit with the required amount of surface area without making the unit nearly as large as the enclosure which it is intended to cool.

In compressor based systems, a refrigerant is used and the cooling function is achieved by the compression and expansion of that refrigerant. The compressor based systems are efficient but are bulky, have relatively high maintenance costs and consume large amounts of electricity. Also, all the cooling is done actively, which may not be necessary when, for example, the ambient outside air is sufficiently cool.

In thermoelectric temperature control systems, thermoelectric devices pump heat using the Peltier effect. The thermoelectric devices are highly reliable and very economical in low wattage applications. As the number of watts to be removed are increased, the cost of this type of system increases as the cost is directly related to the number of thermoelectric devices that are needed for the particular function. The cooling capacity of a thermoelectric system may also be limited by power supply requirements as large numbers of thermoelectric devices require a significant amount of power to operate.

The most typical thermoelectric (TEC) device incorporates a thermoelectric module/component that utilizes electrical current to absorb heat from one side of the module and dissipate that heat on the opposite side. If the current direction is reversed, so is the heat pumping. Generally, cold sides and hot sides are developed necessitating an effective means of removing or adding heat from or to a solid, liquid or a gas (typically air).

Yet another system conditions the air in an electronic enclosures utilizing the above referenced TEC device in a low cost, reliable, efficient manner. The hybrid systems set forth in U.S. Pat. Nos. 5,890371 and 6,058,712, as noted above, provide an improvement over the prior art by eliminating the need for refrigerant while providing high energy efficiency with improved cooling capacity, low maintenance, low cost, and low noise, and which is light weight and compact.

However, a need still exists for a passive cooling system which conditions the air in an electronic enclosure in a low cost, reliable manner, that maximizes efficiency. The present invention provides such a system by providing a heat exchanger core that uses a multiplicity of low profile extrusions and the ability to design-in performance enhancing characteristics such as internal and external fins as discussed herein. The use of low profile extrusions reduces size for the same amount of cooling as compared with folded fin approaches due to the ability to tailor the distance between the low profile extrusions and dimensions of the extrusions to optimize its performance.

As used in this document, the term “low profile extrusion” refers to an integral or unitary piece of metal having a series of micro extruded hollow tubes or channels formed therein for containing a fluid (i.e., liquid or gas). The micro tubes or channels will typically have an effective diameter ranging from about 0.0625 inches to about 0.5000 inches, but can also have significantly smaller or larger diameters.

Preferred low profile extrusions are sold by Thermalex, Inc. of Montgomery, Ala. A brochure entitled “Thermalex, Inc.—Setting A Higher Standard in Aluminum Extrusions” (hereinafter the “Thermalex Brochure”) provides additional detail regarding the Thermalex low profile extrusions and is incorporated herein by reference. U.S. Pat. No. 5,342,189, which is incorporated herein by reference, provides additional detail regarding an extrusion die for making such low profile extrusions. U.S. Pat. No. 5,353,639, which is incorporated herein by reference, provides additional detail regarding a method and apparatus for sizing a plurality of micro extruded tubes used in such low profile extrusions. These low profile extrusions are commercially available in strip form (having a generally rectangular geometry) or coil form (a continuous strip which is coiled along its length for efficient transport).

It is notable, that although the micro tubes or channels described herein have an effective diameter, because the low-profile extrusion is formed of a single piece of metal which is extruded, it is possible to form channels with square, rectangular, or almost any geometry. Moreover, it is possible to extrude fins, grooves or wick structures on the interior of the channels without any additional machining steps. The low profile extrusions preferably have multi-void micro extruded tubes designed to operate under the pressures and temperatures required by modern environmentally safe refrigeration fluids and to resist corrosion. Such low profile extrusions are preferably formed from aluminum, although it is possible to use other metals or alloys which are sufficiently malleable to be extruded and have relatively high heat conductivity.

### SUMMARY OF THE INVENTION

The present invention relates to an air conditioning apparatus and method for cooling enclosures containing electronic equipment. More particularly, one aspect of the present invention comprises a low cost passive heat removal system that utilizes a plurality of flat tubing or low profile extrusions. The flat tubing or low profile extrusions are arranged in parallel to create an air-to-air passive heat exchanger which may be incorporated into an air conditioning apparatus constructed in accordance with the present invention. The flat tubes or low profile extrusions offer a greater surface area and more efficient cooling than conventional folded fin designs having the same overall dimensions or volume. Moreover, the flat tubes or low profile extrusions may be manufactured with dimples, fins, or other surface enhancements with little additional labor or manufacturing steps. The air-to-air passive heat exchanger may be arranged in various configurations including cross flow, counter flow or concurrent flow, and a variety of heat exchange fluids may be utilized.

### BRIEF DESCRIPTION OF THE DRAWINGS

Other advantages and features of the invention will become more apparent with reference to the following detailed description of a presently preferred embodiment thereof in connection with the accompanying drawings, wherein like reference numerals have been applied to like elements, in which:

FIG. 1 is a schematic diagram showing the air flow and heat exchange between a cooling system constructed in accordance with the present invention and the heat producing equipment;

FIG. 2A is a cross sectional view of a low profile extrusion having a plurality of rectangular tubes or channels with internal fins;

FIG. 2B is top perspective view of a folded flat tube which may be used in place of a low profile extrusion;

FIG. 3 is an exploded view of one embodiment of the passive cooling system of the present invention;

FIG. 4 is a front perspective view of one embodiment of the passive heat exchanger mounted within a housing, with the front panel removed for viewing the elements, and with the heat exchanger installed in a chimney configuration within the enclosure which shelters the heat producing equipment; and

FIG. 5 is a side elevational view of another embodiment of the passive heat exchanger mounted within a housing, with the side panel removed for viewing the elements, and with the heat exchanger installed in a wall mounting configuration within the enclosure which shelters the heat producing equipment.

### DETAILED DESCRIPTION

The low profile extrusion air-to-air heat exchanger was developed to meet two major criteria for the telecommunications industry: 1) high heat transfer capacity and 2) minimum depth/weight requirement for base station temperature control. As watt densities continue to increase with ever increasing power requirements, greater heat transfer capacity is necessary in a smaller package. Also, as heat exchanger equipment is commonly door or wall mounted in base stations for use in the telecommunications industry, the depth and weight of the heat exchanger must be minimized. The high capacity aluminum low profile extrusion air-to-air heat exchanger provides the telecommunications industry with a system that meets their needs by providing a design with maximized heat transfer area and minimized depth and weight measurements.

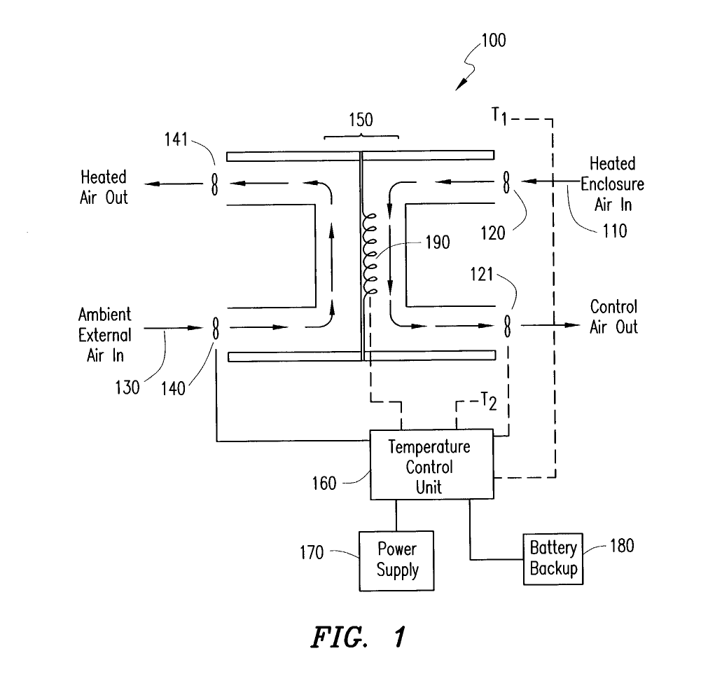

With reference now to FIG. 1, a schematic diagram is presented to show airflow and heat exchange between a cooling system constructed in accordance with present invention and the heat producing equipment sealed within an enclosure. This schematic diagram illustrates a simplified version of an air-to-air passive heat exchanger 100. In operation, heated air 110 is drawn from the enclosure by a fan or blower 120, passed through the exchanger core 150 where heat is removed and then returned to the enclosure containing electronic equipment. The actual cooling of the internal air 110 is carried out by circulation of ambient external air 130 which is drawn in by a fan or blower 140, passed through the exchanger core 150 where heat is received and then expelled out into the environment. As shown in FIG. 1, the cooling system 100 will have at least one fan or blower 120 for the enclosure air side and at least one fan or blower 140 for the external air side, but it is to be understood that additional fans 121, 141 maybe used for redundancy or greater efficiency and that these fans may be of an axial bladed fan design, a curved impeller blower design, or any other suitable fan or blower means for circulating air throughout the system 100 as known in the art.

In operation, temperature readings will normally be taken on the enclosure side of the system with a T₁ being measured at the heated enclosure air-in and a T₂ being measured at the cooled air-out. By comparing the value of T₁ and T₂, it is possible to determine the amount of heat removed by the passive heat exchanger core for a particular rate of airflow. The temperature sensors and the fans on both the enclosure and the external side of the cooling system 100 are all linked together by an electronic control loop, referred to herein as a temperature control unit 160. The temperature control unit 160 uses a micro controller to take the temperature sensor readings T₁, T₂ and adjust the fan speeds to maintain the enclosure at a desired temperature or within a predetermined temperature range. As the temperature measured at T₁ increases, it is possible to increase the air flow rates of the fans proportionally. Byway of example only, it is possible to run the internal fans 120, 121 at a rate of 50% capacity at all times and to gradually ramp their capacity up to 100% or full capacity as T₁ approaches a maximum acceptable level. Similarly, it is possible to allow the external fans 140,141 to run at reduced capacity or to simply be cycled on and off at various times depending on the amount of heat which needs to be removed from the system. By way of example only, it is possible to have the external fan or blower 140 at 50% capacity at a temperature of about 15° C. and then ramp up to 100% capacity at a temperature of about 30° C. The temperature control unit 160 can vary the amount of power which is sent from the power supply 170 to the various fans (e.g. 120, 121, 140, 141) to proportionally control the airflow rates through both the enclosure side and the external side of the heat exchanger 100. It is also possible to monitor fan speeds using Hall effect sensors (not shown) to compute RPM values. The fan performance data may be transmitted to a computer network or other electronic means for signaling equipment failure or unacceptable temperature conditions to a system operator at a remote location.

Still referring to FIG. 1, the operation of the present invention will be discussed. Upon activation of the heat producing equipment (not shown) and the temperature control unit 160 by an electrical power source (not shown) the temperature sensors begin to monitor the temperature within enclosure. When the signal to the power supply 170, from the temperature control unit 160, indicates that the temperature of the air within enclosure has reached a first predetermined value, the microprocessor and software in the temperature control unit 160 will cause the power supply 170 to activate internal fan assembly 120. The warm or heated air 110 will be drawn from enclosure, passed over the surfaces of the passive heat exchanger which are on the enclosure side of the cooling system, and then will be discharged back into enclosure. It will be appreciated that during the flow of the warm or heated air 110 some of the heat therein will be transferred through the wall to the surfaces of the passive heat exchanger which are on the outside-air side of the wall.

In some particularly cold environments, it may be desirable to add a heater 190 to the enclosure side of the passive heat exchanger 100. If the temperature control unit 160 receives a T₁ temperature reading below a predetermined threshold value, it could activate the internal fan assembly 120 and the heater 190 to warm the air within the enclosure to the threshold value. Once the desired minimum T₁ value is achieved, the heater 190 is turned off. The heater 190 may be powered by AC or DC voltage and be of any number of designs or configurations, as known in the art, which will not significantly interfere with airflow through the heat exchanger. One preferred heater design would be a substantially flat or very low profile heating element which may be mounted directly to the exterior surfaces of the flat tubing or low profile extrusions. Thus, the heater may be located within the heat exchanger core itself and require little or no additional space within the enclosure.

By way of example only, a brief summary of exemplary temperature control and system operating steps might be as follows. For a −45° C. outside cold start, the temperature control unit 160 would turn on an AC heater 190 and draw on an AC/DC power supply 170 for one or more internal fans 120. Once the interior of the enclosure is heated to about −5° C., the DC power is available and would take over the internal fans 120. The external fans 140 would be needed to run only when the internal temperature T₁ is in excess of about 20° C. At about 20° C., the external fans 120 might be run at 50% speed and ramp to 100% speed at 35° C. to improve fan life, reduce noise and provide the needed air movement for the cooling the air within the enclosure.

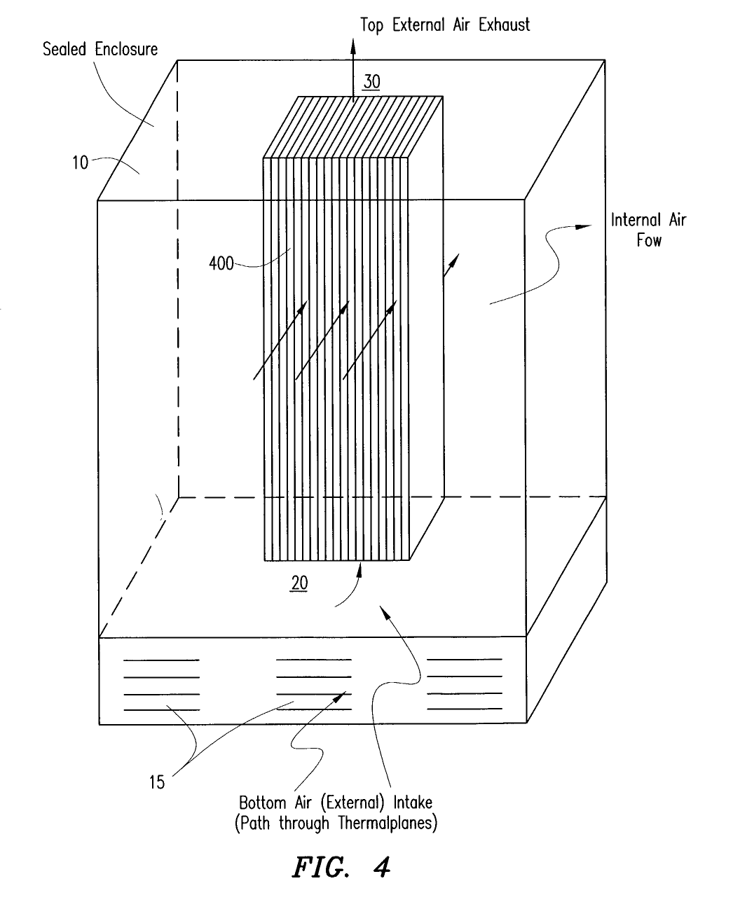

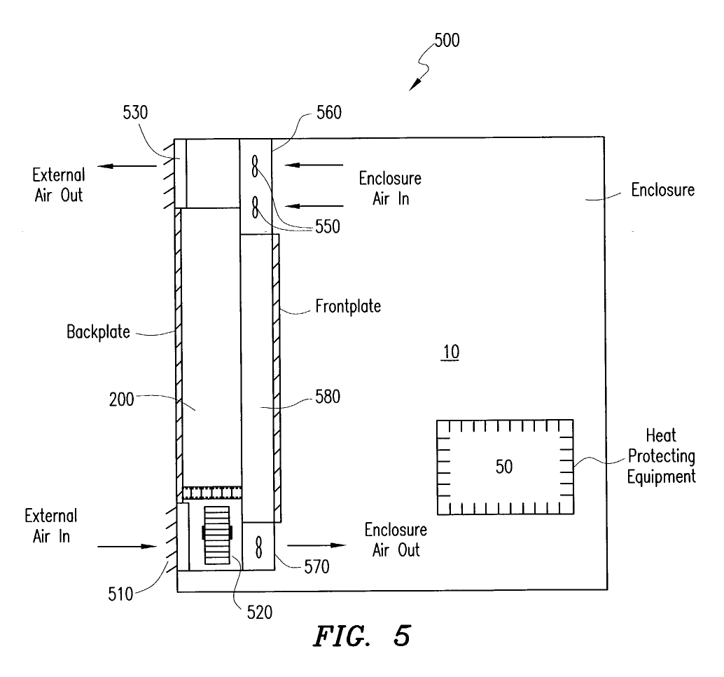

It will be appreciated that each fan assembly can be controlled separately so that both fan assemblies can be on at the same time, both fan assemblies can be off at the same time and each fan assembly can be on at different times. Fan assembly 120 provides movement of the air 110 from the enclosure through a portion of the passive heat exchanger 100, and will be shown in more detail in the discussion of FIGS. 4 and 5. Similarly, fan assembly 140 provides movement of the ambient or outside air 130 through a different portion of the passive heat exchanger 100, and will be also shown in more detail in the discussion of FIGS. 4 and 5.

As previously noted, the temperature control unit 160 regulates a DC voltage from the power supply 170 to be passed the fans or blowers (e.g. 120, 121, 140, 141) throughout the system 100. Also connected to temperature control unit 160 is a battery backup 180. In one embodiment, the temperature control unit 160 may include a switching device having a normally open relay operatively connected such that, if the DC power from the electrical power supply 170 fails, the switching device will engage the battery backup 180 to power the cooling system 100 so that it will remain operable. In one preferred embodiment, the battery backup 180 will be either 24 volt DC or 48 volt DC.

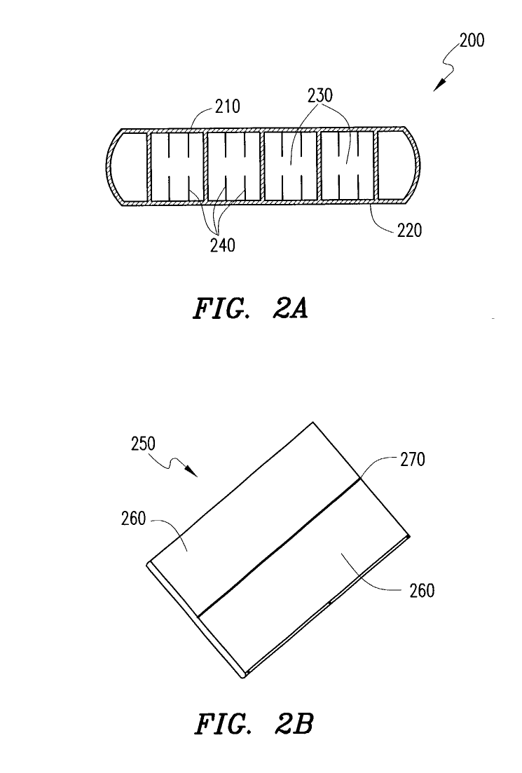

Referring now to FIG. 2A, an exemplary low profile extrusion 200 is shown in a cross sectional view. As illustrated here, the low profile extrusion 200 is generally rectangular in shape with a flat top 210 and bottom 220 portions and rounded at the extreme left and right edges. Internally, the low profile extrusion 200 is shown having a plurality of generally rectangular tubes or channels 230 through which air or other fluids may pass. Still referring to FIG. 2A, it is seen that the channels 230 may have internal fins 240 or other structures for providing additional surface area and for creating turbulent flow. It is also to be understood that other channel or tube geometries may be selected, various fin shapes may be used and that external fins (not shown) may be designed into the low profile extrusion as well. Although some mechanical strength may be lost, it is also possible to form low profile extrusion such as these without internal partitions forming individual tubes or channels. Thus, it is possible to form a low profile extrusion having a single internal flow path extending through its length with a plurality of fins or wick structures formed on the inside.

With reference now to FIG. 2B, a folded flat tube conduit 250 is shown. The folded flat tube 250 may be used as an alternative to the low profile extrusion 200 as illustrated in FIG. 2A. The folded flat tube 250 may be constructed from a single sheet of metal 260 which is folded over at the edges and welded 270 to form a flat conduit 250 with a relatively large surface area and a low profile. Typically, a folded flat tube for use with the present invention may be about 1.0 to about 4.0 inches across and about 0.20to about 0.50 inches in thickness. Although it would be difficult to create internal fins in a folded flat tube, it is possible to dimple or emboss the internal surface of the tube to promote turbulent fluid flow. Of course, fins or other surface enhancements may be added to the external surface with additional welding or machining steps.

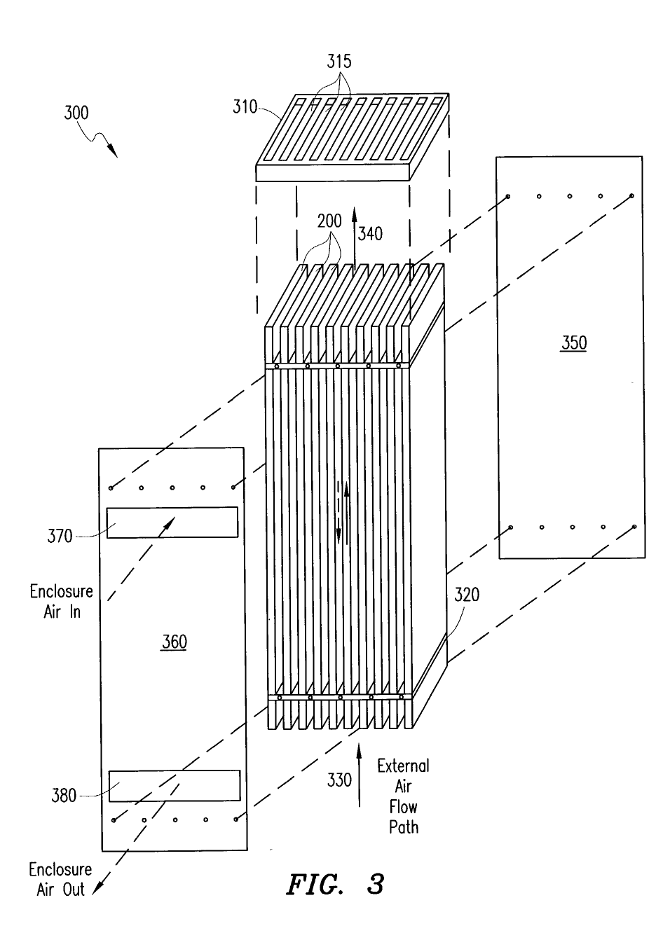

Referring now to FIG. 3, an exploded view of an air-to-air passive heat exchanger core 300 is set forth and described. The passive heat exchanger core 300 is constructed from an arrangement of folded flat tubing 250 or low profile extrusions 200 which have been arranged in a parallel manner with a predetermined gap or spacing between each of the flattened tubes 250 or extrusions 200. The low profile extrusions 200 are held in proper spacing and parallel alignment by upper 310 and lower 320 endcaps. Both the upper 310 and lower 320 endcaps have openings 315 passing completely therethrough for each of the low profile extrusions 200 and provide a solid cap or seal at both the top and bottom of the exchanger core 300 between the extrusions 200. By using this type of construction, it is possible to completely isolate two distinct air flow paths. The first air flow path passes internally through the channels 230 within each of the low profile extrusions 200 and in one embodiment enters at the bottom 330 or lowermost portion of the heat exchanger 300 and exits at the top 340 or uppermost portion of the heat exchanger 300. The second airflow path passes between the low profile extrusions 200 or through the gaps between the extrusions 200. This may be done in a cross flow manner simply by blowing air between the extrusions 200. In yet another embodiment, a solid back plate 350 is placed on one side of the heat exchanger 300 completely covering all of the gaps or spaces between the low profile extrusions 200 and a front plate 360 is placed on the opposite side of the heat exchanger 300 with an intake opening 370 cut slightly below the upper endcap 310 and an output opening 380 cut slightly above the lower endcap 320. By allowing air from the enclosure to enter 370 and exit 380 at only these points, the airflow will be counter-current to the air flow within the low profile extrusions 200.

With reference now to FIG. 4, a front perspective view of a sealed enclosure 10 containing electronic equipment (not shown) is illustrated with a passive heat exchanger 400 located near its center in a chimney configuration. This arrangement of the heat exchanger 400 may be referred to as a chimney configuration as cool external air is drawn in through vents 15 at the bottom 20 of the enclosure 10 and fed upwardly through the internal pathway of the low profile extrusions to pick up heat from the exchanger core 400 as it rises and then exits to exhaust the heated air back into the atmosphere from the top 30 of the enclosure 10. Thus, heat is transferred and removed from the housing 10 to the external environment in a generally upward direction much like smoke rising through a chimney. As depicted in FIG. 4, the internal air flow within the enclosure is in cross-flow but it is understood that suitable baffle plates or ducting maybe used to create counter-current or concurrent flow as well.

Referring now to FIG. 5, there is shown a side elevational view of a sealed electronic enclosure 10 having a low profile wall mounting heat exchanger 500. It is noted that the wall mount configuration of the heat exchanger offers a minimal internal footprint within the enclosure 10 and may also be mounted to a door of the enclosure 10 as well as the fixed side walls. As specifically shown in FIG. 5, the wall or door mounting unit 500 may have a lower external air intake 510 with at least one curved impeller type blower 520 for drawing air into and pushing upward through the low profile extrusions 200 and to exit through an upper opening in the door or wall for external air exhaust 530. The internal side of the wall mounted heat exchanger 500 may feature a plurality of flat axial bladed fans 550 mounted between the upper and lower endcaps and positioned to draw warm air through an upper opening 560 from near the top of the housing 10 and to expel cooled air through an lower opening 570 near the bottom portion of the housing 10. Heat is exchanged in a counter-current flow arrangement between the cooling external air rising upward within the low profile extrusions and the heated internal air descending downward between or in the gaps of the low profile extrusions. As shown in FIG. 5, if there is space between the low profile extrusions 200 and the front plate or back plate, auxiliary fins 580 may be attached to the edges of the extrusions 200 to ensure that all enclosure side airflow within the heat exchanger 500 is confined to the gaps between the extrusions 200. Also, it is to be understood that the flow directions may be reversed and that the types of fans or blowers may be switched as appropriate without departing from the spirit of the invention.

Due to the low depth design feature, this embodiment 500 is ideal for providing high watt density heat removal from the heat producing equipment 50 while minimizing the outer dimension of the electronic enclosure 10. Still referring to FIG. 5, outside air is moved using fans through the low profile extrusions, and inside air is moved using fans in a counter-flow fashion through the spaces or gaps between the extrusions. The heat transfer in the space between the extrusions can be enhanced using folded fins, plates, or media that are in contact with the outer surfaces of the extrusions to increase surface area and/or air flow turbulence. Heat is removed from the inside air loop before returning into the base station, while heat is gained in the outside air loop and moved to the outdoor environment. Top and bottom endcaps are used to keep the inside and outside air streams separated. Airflow can also be reversed, that is, by moving inside air through the extrusions and outside air through the space between the extrusions.

From the foregoing detailed description, it can be appreciated that the present invention is capable of conditioning the air in an enclosure which shelters heat producing equipment by a low cost passive heat removal system to remove heat. The method of cooling the air using an efficient passive heat removal system reduces the need for a large number of active cooling devices thus reducing the cost of such systems while making them energy efficient.

It is to be understood that, although the present system uses air as the working fluid for carrying out heat exchange, it is possible to use other working fluids with the exchanger core as well. By way of example only, the cooling external loop may be closed and filled with working fluids such as freon (H-134A), ethylene glycol, water, etc., which may make use of evaporative cooling at relatively low temperatures. Of course, this type of hybrid cooling system is would add some complexity and would further require a series of pumps and condensers to be incorporated into the external side of the cooling loop.

While preferred embodiments of the present invention have been described in the examples and foregoing description, it will be understood that the invention is not limited to the embodiments disclosed, but is capable of numerous rearrangements and modifications of parts and elements without departing from the spirit of the invention, as defined in the following exemplary claims. Therefore, the spirit and the scope of the appended exemplary claims should not be limited to the description of the preferred embodiments contained herein.

What is claimed is:

1. A system for conditioning the air within an enclosure which houses heat producing equipment, said system comprising:
a heat removal unit comprising an air-to-air passive heat exchanger having a plurality of low profile extrusions arranged in parallel for cooling air warmed by said heat producing equipment within said enclosure and returning cooled air to said heat producing equipment;
said heat removal unit being adapted for transferring heat from said warm air to an outside of said enclosure;
at least one fan;
a power control system for activating said fan to circulate air within said enclosure to maintain the temperature of the air therein below a predetermined value;
sensor means positioned within said enclosure to monitor temperature within said enclosure, said sensor means being connected to said power control system for providing an input that is indicative of the temperature within said enclosure; and
wherein said air-to-air passive heat exchanger is adapted to circulate ambient cooling air within the plurality of low profile extrusions and remove heat from warm air passing between the plurality of low profile extrusions arranged in parallel.
